(19) United States
(12) Patent Application Publication
(10) Pub. No.: US 2025/0008933 A1
(43) Pub. Date: Jan. 9, 2025

(54) METHOD FOR OPTIMIZING GROWTH OF CRUSTACEAN SET

(71) Applicant: ID WATER CO., LTD., Taipei (TW)

(72) Inventors: HAN-TSUNG PAN, Taipei (TW); HUA TU, Taipei (TW); WAN-ZHOU YU, Taipei (TW)

(21) Appl. No.: 18/672,018

(22) Filed: May 23, 2024

(30) Foreign Application Priority Data
Jul. 5, 2023 (TW) 112125157

(51) Int. Cl. A01K 61/59

(52) U.S. Cl. CPC A01K 61/59

(57) ABSTRACT

A method for optimizing a growth of a crustacean set. The method comprises: acquiring, from a memory unit, history data associated with an ecdysis of the crustacean set; determining, by a processing unit, an estimation of the ecdysis information of the crustacean set based on the history data associated with the ecdysis of the crustacean set by a mathematical model describing a relationship set between the history data associated with the ecdysis of the crustacean set and the ecdysis information of the crustacean set; and determining, by the processing unit, an execution of an instruction for farming the crustacean set based on the estimation of the ecdysis information of the crustacean set.

### CROSS-REFERENCE TO RELATED APPLICATIONS

This application claims the benefit of Taiwan patent application No. TW112125157, filed on Jul. 5, 2023, which is hereby incorporated herein by reference.

### BACKGROUND OF THE INVENTION

### 1. Field of the Invention

The present invention relates to a method for optimizing a growth of a crustacean set, and more particularly to a method for determining an execution of an instruction for farming the crustacean set based on the ecdysis information of the crustacean set.

### 2. Description of Related Art

In the aquaculture of a crustacean set, the farmers are desired for a maximum harvest and a minimum cost by optimizing a growth of a crustacean set.

For example, the farmers may aim for the highest growth rate with the lowest mortality. About the mortality of the crustacean set, an ecdysis of the crustacean set should be taken into account among the several biological properties of the crustacean set. Take the crustacean set being a shrimp (set) for example; in the ecdysis duration, the shrimp exposed from the old shell is so weak that it may be attacked by another aquatic animal and further it may die. Therefore, the mortality mitigation process is needed.

For example, the farmers may aim for the highest growth rates by using the least amount of feed to produce a desired output. When performing a feeding process, several challenges may be faced: (1) It is hard to provide the reasonable feed. Providing more feed than what is required for normal growth may result in food waste and an increasing feed expense; the food waste may worsen the water quality, the worsened water quality may affect the health of the farmed aquatic animal and may reduce the quality of the final product (i.e. aquatic animal). Providing less food than what is required for normal growth may affect the growth rate and the health of the farmed aquatic animal and may reduce the quality of the final product (i.e. aquatic animal). Because the feeding cost is more in the total production expense of the aquiculture, feeding management is one of the most important topics in the aquiculture; (2) A manual process of monitoring/adjusting feed is often time-consuming and expensive. Besides, a manual process of monitoring/adjusting feed is not efficient. For example, the farmers need to be on site to monitor the activity of the farmed aquatic animal. In the worst case, the adverse weather condition may decrease the availability of human observers; (3) the biological property should be taken into account. Take the crustacean set being a shrimp (set) for example; in the ecdysis duration, the shrimp does not perform an activity and does not have a desire for eating; besides, the shrimp exposed from the old shell is very weak and the new shell is too soft (not hardened) to support the body of the shrimp even if the new shell is grown, so it is not suitable for the shrimp to eat. Based on the above description, it is not efficient to feed the shrimp in the ecdysis duration of the shrimp.

Accordingly, the present invention proposes a method for optimizing a growth of a crustacean set to overcome the above-mentioned disadvantages.

### SUMMARY OF THE INVENTION

The present invention proposes a method for optimizing a growth of a crustacean set based on the biological property of the crustacean set. The crustacean set has a biological property about an ecdysis. Compared non-ecdysis state, more instructions for farming the crustacean set are needed in the ecdysis state, such as a mortality mitigation instruction and a feed-controlling instruction. Therefore, the present invention builds up a mathematical model describing a relationship set between the history data associated with the ecdysis of the crustacean set and the ecdysis information of the crustacean set to determine an estimation of the ecdysis information of the crustacean set based on the history data associated with the ecdysis of the crustacean set. The history data has a corresponding data portion associated with at least one key factor and a combination of at least one key factor is highly associated with the ecdysis of the crustacean set. The combination of at least one key factor highly associated with the ecdysis of the crustacean set is fully taken into account in the mathematical model, so the present invention can precisely determine the estimation of the ecdysis information of the crustacean set based on the combination of at least one key factor and further precisely determine an execution of an instruction for farming the crustacean set based on the precise estimation of the ecdysis information of the crustacean set.

By the algorithm implemented in the computer of the present invention, the computer of the present invention performs operations described in claims or the following descriptions to determine an execution of an instruction for farming the crustacean set based on an estimation of the ecdysis information of the crustacean set.

In one embodiment, the present invention discloses a method for optimizing a growth of a crustacean set. The method comprises: (a) acquiring, from a memory unit, history data associated with an ecdysis of the crustacean set; (b) determining, by a processing unit, an estimation of the ecdysis information of the crustacean set based on the history data associated with the ecdysis of the crustacean set by a mathematical model describing a relationship set between the history data associated with the ecdysis of the crustacean set and the ecdysis information of the crustacean set; and (c) determining, by the processing unit, an execution of an instruction for farming the crustacean set based on the estimation of the ecdysis information of the crustacean set.

In one embodiment, the present invention discloses a method for optimizing a growth of a shrimp set. The method comprises: (a) acquiring, from a memory unit, history data associated with an ecdysis of the shrimp set; determining, by a processing unit, an estimation of the ecdysis information of the shrimp set based on the history data associated with the ecdysis of the shrimp set by a mathematical model describing a relationship set between the history data associated with the ecdysis of the shrimp set and the ecdysis information of the shrimp set; and (c) determining, by the processing unit, an execution of an instruction for farming the shrimp set based on the estimation of the ecdysis information of the shrimp set; wherein a duration has a first time point and a second time point, wherein the second time point is in the duration beginning at the first time point, wherein the ecdysis information of the shrimp set is at the second time point and the ecdysis information of the shrimp set at the second time point is determined at the first time point; wherein the history data has a corresponding data portion associated with each of at least one factor, wherein the at least one factor is associated with the ecdysis of the shrimp set, wherein the at least one factor comprises a biological factor of the shrimp set, a feeding factor and an environment factor; wherein the history data associated with the ecdysis of the shrimp set comprises history ecdysis data of a different shrimp set associated with the shrimp set, wherein the different shrimp set associated with the shrimp set is determined by a criterion, wherein the criterion is determined based on a similarity of the biological factor of the shrimp set.

In one embodiment, the present invention discloses a method for optimizing a growth of a shrimp set. The method comprises: (a) acquiring, from a memory unit, history data associated with an ecdysis of the shrimp set; (b) determining, by a processing unit, an estimation of the ecdysis information of the shrimp set based on the history data associated with the ecdysis of the shrimp set by a mathematical model describing a relationship set between the history data associated with the ecdysis of the shrimp set and the ecdysis information of the shrimp set; and (c) determining, by the processing unit, an execution of an instruction for farming the shrimp set based on the estimation of the ecdysis information of the shrimp set; wherein a duration has a first time point and a second time point, wherein the second time point is in the duration beginning at the first time point, wherein the ecdysis information of the shrimp set is at the second time point and the ecdysis information of the shrimp set at the second time point is determined at the first time point; wherein the history data has a corresponding data portion associated with each of at least one factor, wherein the at least one factor is associated with the ecdysis of the shrimp set, wherein the at least one factor comprises a biological factor of the shrimp set; wherein the history data associated with the ecdysis of the shrimp set comprises history ecdysis data of a different shrimp set associated with the shrimp set, wherein the different shrimp set associated with the shrimp set is determined by a criterion, wherein the criterion is determined based on a similarity of growth history of the shrimp set.

The detailed technology and above preferred embodiments implemented for the present invention are described in the following paragraphs accompanying the appended drawings for people skilled in the art to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a schematic block diagram of an exemplary apparatus in the present invention;

FIG. 2 illustrates a method for optimizing a growth of a crustacean set;

FIG. 3A illustrates the history data, an estimation/prediction of the ecdysis information of the crustacean set and the ecdysis information of the crustacean set in an order in the axis of time;

FIG. 3B illustrates the early history data, the history data, an estimation/prediction of the ecdysis information of the crustacean set and the ecdysis information of the crustacean set in an order in the axis of time;

FIG. 4A illustrates a second embodiment in step 22 of the present invention, wherein the history data associated with the ecdysis of the crustacean set is history ecdysis data of the crustacean set;

FIG. 4B illustrates a second embodiment in step 22 of the present invention, wherein the history data associated with the ecdysis of the crustacean set is history ecdysis data of a different crustacean set associated with the crustacean set;

FIG. 4C illustrates a second embodiment in step 22 of the present invention, wherein the history data associated with the ecdysis of the crustacean set comprises first history ecdysis data of a different crustacean set associated with the crustacean set and second history ecdysis data of the crustacean set;

FIG. 5 illustrates a third embodiment in step 22 of the present invention; and

FIG. 6 illustrates a fourth embodiment in step 22 of the present invention.

### DETAILED DESCRIPTION OF THE ILLUSTRATED EMBODIMENTS

The detailed explanation of the present invention is described as following. The described preferred embodiments are presented for purposes of illustrations and description and they are not intended to limit the scope of the present invention.

### Definition of the Terms

### Ecdysis

Ecdysis is an act of molting or shedding an outer cuticular layer. A crustacean may have an ecdysis in its growth.

### Crustacean

A crustacean is an animal with a shell and several pairs of legs. The crustacean usually lives in water and has an ecdysis in its growth. The crustacean may comprise a shrimp, a lobster or a crab. Take a shrimp (set) for example for convenience of description in some following cases; however, the present invention is not limited to this case.

### Crustacean Set

The crustacean set may be a crustacean or a plurality of crustaceans. A plurality of crustaceans may be farmed in the enclosure (e.g., farming pool).

### Different Crustacean Set

The different crustacean set may be also a crustacean or a plurality of crustaceans. A plurality of crustaceans may be farmed in the enclosure (e.g., farming pool). The different crustacean set is different from the crustacean set in the previous paragraph.

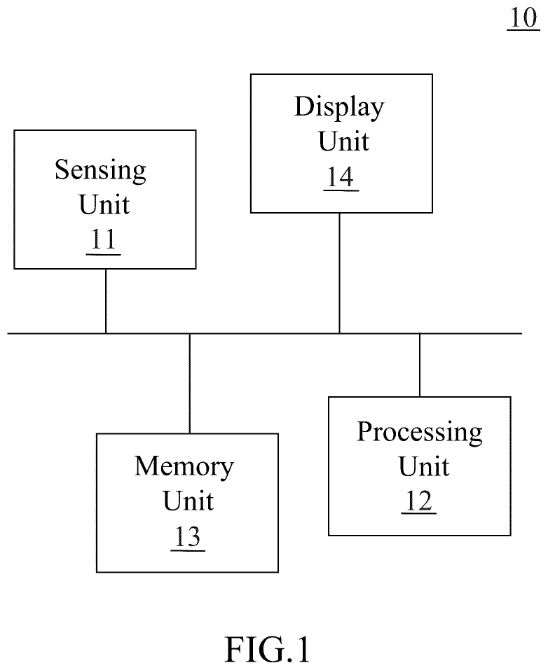

The method in the present invention may be applied in all kinds of apparatuses, such as a measurement system, a mobile device, a mobile phone, a portable device, a personal computer, a server or a combination thereof. FIG. 1 illustrates a schematic block diagram of an exemplary apparatus 10 in the present invention. The apparatus 10 may comprise a sensing unit 11 (e.g., at least one sensor), a processing unit 12, a memory unit 13 and a display unit 14. One unit may communicate with another unit in a wired or wireless way.

The apparatus 10 may comprise at least one first device; in one embodiment, the sensing unit 11 may be in one first device adjacent to the sensed object and the processing unit 12 may be in another first device (e.g., a mobile device, a mobile phone, a portable device, a personal computer or a server) far from the sensed object; in another embodiment; the sensing unit 11 and the processing unit 12 may be in a single first device. The processing unit 12 (e.g., control unit) may send a control/instruction to the sensing unit 11 to acquire the desired data from the sensing unit 11; for example, the control/instruction may be used to adjust the configuration parameters of the sensing unit 11 to acquire the quality data (it may be applied in a movable/fixed sensor); for example, the control/instruction may be instruct the sensing unit 11 to move to a specific location to acquire the quality data (it may be may be applied in a movable sensor). The sensing unit 11 may transmit the measurement data to the processing unit 12 for the subsequent data processing/computing. The sensing unit 11 may be a sensor, such as an image sensor and an acoustic sensor.

The processing unit 12 may be any suitable processing device for executing software instructions, such as processor and a central processing unit (CPU). The processing unit 12 may comprise a computing unit. The apparatus 10 may comprise at least one second device; a first portion (e.g., the more computing ability) of the computing unit may be in one second device (e.g., a server or a cloud server), a second portion of the computing unit may be in another second device (e.g., a mobile device, a mobile phone, a portable device or a personal computer) and a first portion of the computing unit may communicate with a second portion of the computing unit in a wired or wireless way; a first portion of the computing unit and a second portion of the computing unit may be in a single second device.

The memory unit 13 may include random access memory (RAM) and read only memory (ROM), but it is not limited to this case. The history data associated with an ecdysis of the crustacean set can be stored in the memory unit 13. The memory unit 13 may include any suitable non-transitory computer readable medium, such as ROM, CD-ROM, DVD-ROM and so on. Also, the non-transitory computer readable medium is a tangible medium. The non-transitory computer readable medium includes a computer program code which, when executed by the processing unit 12, causes the apparatus 10 to perform desired operations (e.g., operations listed in claims).

The display unit 14 may be a display for displaying an execution of an instruction for farming the crustacean set. Optionally, the related data of the instruction for farming the crustacean set can be are also displayed, such as the history data associated with an ecdysis of the crustacean set. The displaying mode may be in the form of words, a voice or an image.

The sensing unit 11, the processing unit 12, the memory unit 13 and the display unit 14 in the apparatus 10 may have any suitable configuration and it doesn't be described in detail therein.

The present invention proposes a method for optimizing a growth of a crustacean set based on the biological property of the crustacean set. The crustacean set has a biological property about an ecdysis. Compared non-ecdysis state, more instructions for farming the crustacean set are needed in the ecdysis state, such as a mortality mitigation instruction and a feed-controlling instruction. Therefore, the present invention builds up a mathematical model describing a relationship set between the history data associated with the ecdysis of the crustacean set and the ecdysis information of the crustacean set to determine an estimation of the ecdysis information of the crustacean set based on the history data associated with the ecdysis of the crustacean set. The history data has a corresponding data portion associated with at least one key factor and a combination of at least one key factor is highly associated with the ecdysis of the crustacean set. The combination of at least one key factor highly associated with the ecdysis of the crustacean set is fully taken into account in the mathematical model, so the present invention can precisely determine the estimation of the ecdysis information of the crustacean set based on the combination of at least one key factor and further precisely determine an execution of an instruction for farming the crustacean set based on the precise estimation of the ecdysis information of the crustacean set.

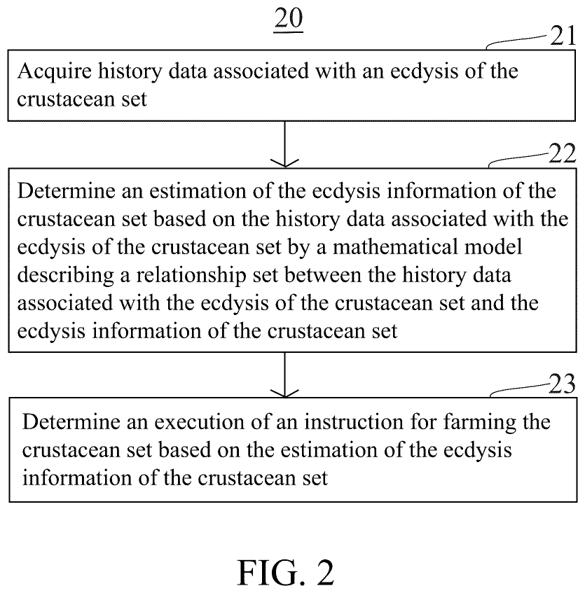

FIG. 2 illustrates a method 20 for optimizing a growth of a crustacean set.

### The Method Comprises:

Step 21: acquire history data associated with an ecdysis of the crustacean set (from a memory unit 13);
Step 22: determine an estimation of the ecdysis information of the crustacean set based on the history data associated with the ecdysis of the crustacean set by a mathematical model describing a relationship set between the history data associated with the ecdysis of the crustacean set and the ecdysis information of the crustacean set (by the processing unit 12);
Step 23: determine an execution of an instruction for farming the crustacean set based on the estimation of the ecdysis information of the crustacean set (by the processing unit 12).

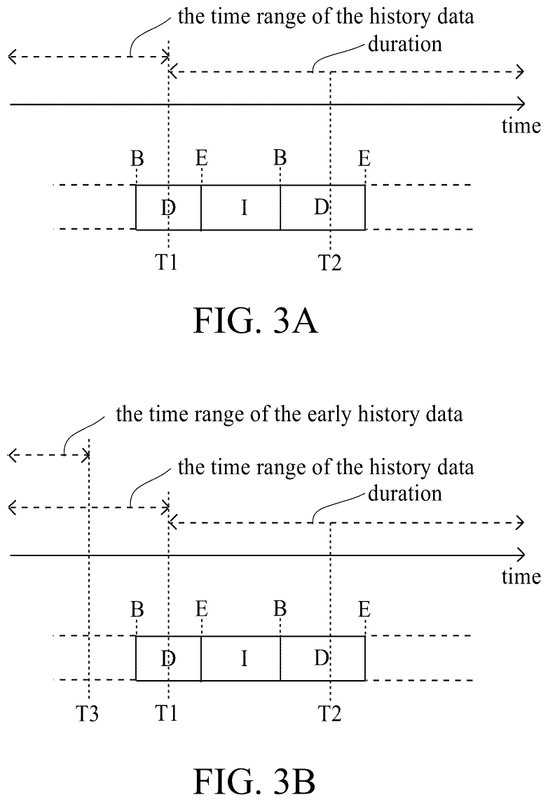

FIG. 3A illustrates the history data, an estimation/prediction of the ecdysis information of the crustacean set and the ecdysis information of the crustacean set in an order in the axis of time. The duration has a first time point T1 and a second time point T2. The duration begins at the first time point T1. The duration may end at a positive infinite point in the axis of time. The second time point T2 is in the duration. The ecdysis information of the crustacean set is at the second time point T2. The estimation/prediction of the ecdysis information of the crustacean set at the second time point T2 is determined at the first time point T1. In general, the execution of the instruction for farming the crustacean set is determined substantially at the first time point T1. In most cases, the second time point T2 is later than the first time point T1; in other words, at the first time point T1 (i.e. current time point), an estimation of the ecdysis information of the crustacean set at the second time point T2 (i.e. future time point) can be determined based on the history data associated with the ecdysis of the crustacean set before the first time point T1. The bottom portion of FIG. 3A shows the actual ecdysis information comprising a plurality of ecdysis durations (with symbol D) and a plurality of ecdysis intervals (with symbol I) alternating with a plurality of ecdysis durations (the ecdysis occurs in the ecdysis duration and the ecdysis doesn't occur in the ecdysis interval). In this case, at the first time point T1 (i.e. current time point), an estimation of the ecdysis information of the crustacean set at the second time point T2 (i.e. future time point) should be in the ecdysis state based on the history data associated with the ecdysis of the crustacean set before the first time point T1 by the mathematical model in step 22. In some case, the second time point T2 may be the first time point T1, which means that at the first time point T1 (i.e. current time point), an estimation of the ecdysis information of the crustacean set at the first time point T1/the second time point T2 (i.e. current time point) can be determined based on the history data associated with the ecdysis of the crustacean set before the first time point T1. In one embodiment, “the second time point T2 being the first time point T1” can be applied in the subsequent portion “Improvement of a Confidence of Using the Mathematical Model”.

The history data has a corresponding data portion associated with each of at least one factor. The at least one factor is associated with the ecdysis of the crustacean set. At least one factor may comprise at least one of a biological factor of the crustacean set, a feeding factor, an environment factor and a history ecdysis factor. At least one factor may comprise a biological factor of the crustacean set, a feeding factor and an environment factor. At least one factor may comprise a biological factor of the crustacean set, a feeding factor, an environment factor and a history ecdysis factor. At least one factor may comprise a biological factor of the crustacean set. At least one factor may comprise a feeding factor. At least one factor may comprise an environment factor. At least one factor may comprise a history ecdysis factor. The relationship set of the mathematical model comprises a relationship subset between the history data associated with the at least one factor and the ecdysis information of the crustacean set.

The biological factor of the crustacean set may comprise an age, a species, a size (e.g., weight, volume, body length), a gender, a body feature and a shell composition. The age may be an important factor affecting the length of the ecdysis duration and the length of the ecdysis interval between two adjacent ecdysis durations; in general, the more the age of the crustacean set is, the more the length of the ecdysis duration is; in general, the more the age of the crustacean set is, the more the length of the ecdysis interval is. In a specific case, the species, the size and the gender may affect the length of the ecdysis duration and the length of the ecdysis interval to a certain degree. The body feature may be a precursor of the ecdysis of the crustacean set appeared in the body of the crustacean set. Take a shrimp (set) for example, when the joint between the head and the lower body becomes larger, the ecdysis duration may come soon. The shell composition may affect the length of the ecdysis duration. Take a shrimp (set) for example, if there are enough elements in the body for forming the shell, the length of the ecdysis duration may decrease.

The feeding factor may comprise a nutrient from the feed and a remaining feed. Take a shrimp (set) for example, the feed deficiency may decrease the nutrient of the shrimp so that the ecdysis of the shrimp may be slowed or stop; in some case, the more remaining feed may represent the low feed deficiency.

The environment factor may comprise a water temperature, a dissolved oxygen and a microorganism. Take a shrimp (set) for example, a poor water quality may decrease the energy of the shrimp so that the ecdysis of the shrimp may be slowed or stop. Take a shrimp (set) for example, some microorganisms which do harm to the shrimp may decrease the energy of the shrimp so that the ecdysis of the shrimp may be slowed or stop. Some probiotics may mitigate microorganisms which do harm to the shrimp.

The history ecdysis factor may comprise a length of a history ecdysis duration, a beginning time of the history ecdysis duration, an ending time of the history ecdysis duration, a length of a history ecdysis interval between two adjacent history ecdysis durations and a history ecdysis ratio of the crustacean set.

The association between at least one factor and the ecdysis of the crustacean set may be found in the biology of the ecdysis of the crustacean set and thus it doesn't be described in detail herein.

The ecdysis information may comprise an ecdysis parameter. The ecdysis parameter may be represented in the form of time when the ecdysis of the crustacean set happens. For example, the ecdysis parameter may comprise at least one of a length of an ecdysis duration (with symbol D in FIG. 3A), a beginning time of the ecdysis duration (with symbol B in FIG. 3A), an ending time of the ecdysis duration (with symbol E in FIG. 3A) and a length of an ecdysis interval (with symbol I in FIG. 3A) between two adjacent ecdysis durations. In some case, the boundary between the ecdysis duration and the ecdysis interval may be not obvious and thus each of the beginning time of the ecdysis duration and the ending time of the ecdysis duration may be also a duration. In some case, the boundary between the ecdysis duration and the ecdysis interval may be not obvious, so the beginning time of the ecdysis duration may be a first reference time in the transition from the ecdysis interval to the ecdysis duration and the ending time of the ecdysis duration may be a second reference time in the transition from the ecdysis duration to the ecdysis interval. Each of the first reference time and the second reference time may be defined based on the farming experience.

It should be noticed that the current ecdysis duration may begin at the beginning time of the current ecdysis duration and end at the ending time of the current ecdysis duration; the current ecdysis interval may begin at the end time of the previous ecdysis duration and end at the beginning time of the next ecdysis duration. In one embodiment, if the crustacean set is in the non-ecdysis state at the current time, the beginning time of the next ecdysis duration can be determined; if the crustacean set is in the ecdysis state at the current time, the ending time of the current ecdysis duration can be determined.

For convenience of understanding, the bottom portion of FIG. 3A further illustrates the ecdysis parameter represented in the form of time when the ecdysis of the crustacean set happens. The ecdysis parameter may be also represented in the other form, such as whether the ecdysis happens or not (i.e. ecdysis state/non-ecdysis state) and an ecdysis ratio of the crustacean set (i.e. if the ecdysis state of each crustacean of the crustacean set is confirmed, the ecdysis ratio of the crustacean set can be determined).

In one embodiment, the history ecdysis factor may be used as a reference time for determining an estimation of the ecdysis information of the crustacean set. For example, on 2020 Jan. 15, the ending time of the latest ecdysis duration (i.e. the history ecdysis factor) is on 2020 Jan. 1, the beginning time of the next ecdysis duration is on 2020 Feb. 1 if the length of the ecdysis interval between two adjacent ecdysis durations (i.e. the ecdysis parameter of the ecdysis information) determined by the mathematical model is 31 days.

The history data associated with the ecdysis of the crustacean set may be the history ecdysis data of the crustacean set. The history data associated with the ecdysis of the crustacean set may be also the history ecdysis data of the different crustacean set associated with the crustacean set. The different crustacean set associated with the crustacean set may be determined by a criterion. The criterion can use a similarity of the parameter. For example, the criterion may be determined based on a similarity of the biological factor of the crustacean set, such as an age, a species, a size (e.g., weight, volume, body length), a gender, a body feature and a shell composition. For example, the criterion may be determined based on a similarity of the growth history of the crustacean set, such as the growth rate. For example, the criterion may be determined based on a similarity of the history feed instruction. For example, the criterion may be determined based on a similarity of the environment factor, such as a water temperature, a dissolved oxygen and a microorganism. For example, the criterion may be determined based on the history ecdysis factor, such as a length of a history ecdysis duration, a beginning time of the history ecdysis duration, an ending time of the history ecdysis duration and a length of a history ecdysis interval between two adjacent history ecdysis durations. For example, the criterion may be determined based on a similarity of the time (e.g., month or season) when the crustacean larva is initially placed. A predefined range can be defined for each parameter. A degree of similarity may be determined based the relationship between the value of the parameter and the predefined range.

There are several embodiments in Step 22. The embodiments are disclosed in the following description.

### First Embodiment in Step 22

The history data has a corresponding data portion associated with each of at least one factor. At least one factor is associated with the ecdysis of the crustacean set. The relationship set of the mathematical model comprises a relationship subset between the history data associated with at least one factor and the ecdysis information of the crustacean. In one embodiment, the estimation of the ecdysis information of the crustacean set may be determined based on a combination of at least one factor. The combination of at least one factor may be a linear combination of at least one factor (e.g., weighted sum). In one embodiment, the mathematical model is a (trained) machine learning model. In one embodiment, the estimation of the ecdysis information of the crustacean set may be determined based on a rule-based method using at least one factor.

### Second Embodiment in Step 22

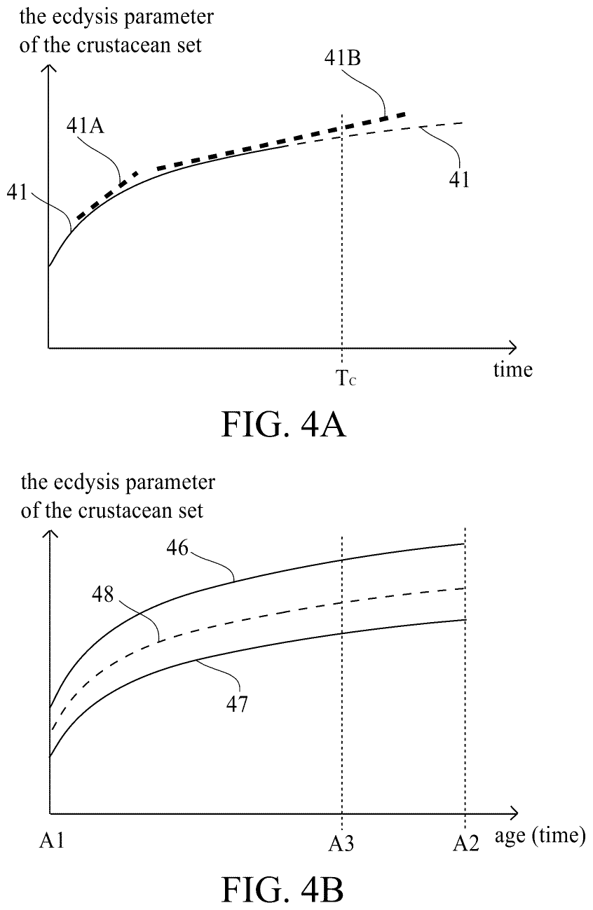

FIG. 4A, FIG. 4B and FIG. 4C illustrate a second embodiment in step 22 of the present invention. Preferably, the ecdysis parameter of the ecdysis information may be represented in the form of time when the ecdysis of the crustacean set happens. The second embodiment in step 22 of the present invention may comprise: acquiring (or determining) a tendency of the ecdysis parameter from (or by using) the history data associated with the ecdysis of the crustacean set; and determining a value of the ecdysis parameter of the crustacean set (e.g., at the time point Tc or A3) based on the tendency of the ecdysis parameter. The relationship set of the mathematical model comprises a first relationship subset between the tendency of the ecdysis parameter and the value of the ecdysis parameter of the crustacean set.

The history data associated with the ecdysis of the crustacean set may be the history ecdysis data of the crustacean set (see FIG. 4A and the solid portion of the tendency 41 is associated with the history ecdysis data of the crustacean set). The time point Tc may correspond to the second time point T2 in FIG. 3A. In one embodiment, the value of the ecdysis parameter of the crustacean set may be determined further based on at least one of the length of the latest ecdysis duration, the beginning time of the latest ecdysis duration, the ending time of the latest ecdysis duration and the length of the latest ecdysis interval between two adjacent ecdysis durations. For example, on 2020 Jan. 15, the ending time of the latest ecdysis duration (i.e. the history ecdysis factor) is on 2020 Jan. 1, the beginning time of the next ecdysis duration is on 2020 Feb. 1 if the length of the ecdysis interval between two adjacent ecdysis durations (i.e. the ecdysis parameter of the ecdysis information; according to the biology of the ecdysis, the more the age of the crustacean set is, the more each of the length of the ecdysis duration and the length of the ecdysis interval between two adjacent ecdysis durations is) determined by the first relationship subset between the tendency 41 of the ecdysis parameter and the value of the ecdysis parameter of the crustacean set in the mathematical model is 31 days.

Further, the value of the ecdysis parameter of the crustacean set may be determined based on a variation rate (e.g., slope) 41A, 41B of the tendency 41 of the ecdysis parameter.

The history data associated with the ecdysis of the crustacean set may be (or comprise) the history ecdysis data of the different crustacean set associated with the crustacean set (see FIG. 4B). The different crustacean set has a first age A1 and a second age A2 larger than the first age A1. For convenience of description, the first age may be in a juvenile period and the second age may be in a harvest period; however, the present invention is not limited to this case. The tendency of the ecdysis parameter between the first age A1 and the second age A2 may be acquired from the history ecdysis data of the different crustacean set associated with the crustacean set; and a value of the ecdysis parameter of the crustacean set at the third age A3 between the first age A1 and the second age A2 may be determined based on the tendency of the ecdysis parameter between the first age A1 and the second age A2. The relationship set of the mathematical model may comprise a first relationship subset between the tendency of the ecdysis parameter of the different crustacean set between the first age A1 and the second age A2 and the value of the ecdysis parameter of the crustacean set at the third age A3. The third age A3 may correspond to the second time point T2 in FIG. 3A. The third age A3 and the second age A2 may be the same.

The tendency 48 of the ecdysis parameter between the first age A1 and the second age A2 may be determined based on a first initial tendency 46 of the ecdysis parameter between the first age A1 and the second age A2 acquired from first data of the history ecdysis data of a first portion of the different crustacean set associated with the crustacean set and a second initial tendency 47 of the ecdysis parameter between the first age A1 and the second age A2 acquired from second data of the history ecdysis data of a second portion of the different crustacean set associated with the crustacean set. In other words, the tendency 48 of the ecdysis parameter between the first age A1 and the second age A2 may be determined based on a plurality of initial tendencies 46, 47 between the first age A1 and the second age A2. The initial tendencies 46, 47 may be acquired based on the previously described criterion. The criterion may be determined based on a similarity of the biological factor of the crustacean set. Specifically, the criterion may be determined based on a similarity of the age of the crustacean set; the criterion may be determined based on a similarity of the species of the crustacean set; the criterion may be determined based on a similarity of the size of the crustacean set. The initial tendencies 46, 47 represent the all kinds of possible tendencies which may comprise some extreme tendencies even if association which meets the criterion exists; therefore, the tendency 48 of the ecdysis parameter between the first age A1 and the second age A2 can be precisely determined based on taking into account all kinds of possible tendencies so as to increase a precision of the estimation of the ecdysis information of the crustacean set. In one embodiment, the tendency 48 of the ecdysis parameter between the first age A1 and the second age A2 may be determined based on a statistical result of a plurality of initial tendencies 46, 47; the statistical result may use a method associated with an average or a median. For example, the tendency 48 of the ecdysis parameter between the first age A1 and the second age A2 may be an average tendency of the initial tendencies 46, 47.

The history data associated with the ecdysis of the crustacean set may comprise first history ecdysis data of a different crustacean set associated with the crustacean set and second history ecdysis data of the crustacean set. In one embodiment (see FIG. 4C), the value of the ecdysis parameter of the crustacean set at the third age A3 between the first age A1 and the second age A2 may be determined further based on the second history ecdysis data of the crustacean set (see the solid portion of the tendency 49); the relationship set of the mathematical model comprises a first relationship subset among the tendency of the ecdysis parameter of the different crustacean set between the first age A1 and the second age A2, the second history ecdysis data of the crustacean set and the value of the ecdysis parameter of the crustacean set at the third age A3. The second history ecdysis data of the crustacean set may comprise at least one of the length of the latest ecdysis duration, the beginning time of the latest ecdysis duration, the ending time of the latest ecdysis duration and the length of the latest ecdysis interval between two adjacent ecdysis durations. For example, on 2020 Jan. 15, the ending time of the latest ecdysis duration (i.e. the second history ecdysis data of the crustacean set) is on 2020 Jan. 1, the beginning time of the next ecdysis duration is on 2020 Feb. 1 if the length of the ecdysis interval between two adjacent ecdysis durations (i.e. the ecdysis parameter of the ecdysis information) determined by the first relationship subset among the tendency of the ecdysis parameter of the different crustacean set between the first age A1 and the second age A2, the second history ecdysis data of the crustacean set and the value of the ecdysis parameter of the crustacean set at the third age A3 in the mathematical model is 31 days.

Further, the value of the ecdysis parameter of the crustacean set may be determined based on a variation rate (e.g., slope) of the tendency of the ecdysis parameter of the different crustacean set between the first age A1 and the second age A2.

Further, the value of the ecdysis parameter of the crustacean set may be determined based on a variation rate (e.g., slope) 49A, 49B of the tendency 49 of the ecdysis parameter of the crustacean set.

Further, the above value of the ecdysis parameter of the crustacean set may be modified based on a portion of the at least one factor, wherein the relationship set of the mathematical model further comprises a second relationship subset between the history data associated with the portion of the at least one factor and the value of the ecdysis parameter of the crustacean set. The portion of the at least one factor may be not used to acquire the tendency of the ecdysis parameter. In other words, the portion of the at least one factor may exclude the factor associated with at least one tendency factor used to acquire/determining the tendency (or the criterion). For example, the age of the crustacean set is used to acquire/determine the tendency of the ecdysis parameter and thus the age of the crustacean set may be excluded in modifying the above value of the ecdysis parameter of the crustacean set.

In one embodiment, the portion of the at least one factor may comprise at least one of a feeding factor and an environment factor. In one embodiment, the portion of the at least one factor may comprise a feeding factor. In one embodiment, the portion of the at least one factor may comprise an environment factor. In one embodiment, the portion of the at least one factor may comprise the body feature. In one embodiment, the portion of the at least one factor may comprise the shell composition.

### Third Embodiment in Step 22

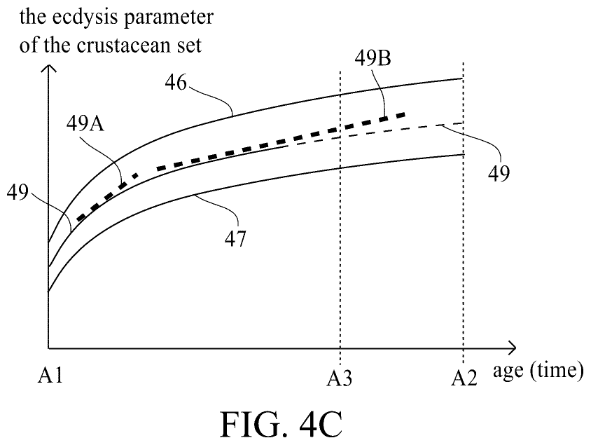

FIG. 5 illustrates a third embodiment in step 22 of the present invention. The history data has a corresponding data portion associated with each of at least one factor (may be used as the input layer of the mathematical model). The at least one factor is associated with the ecdysis of the crustacean set. From a point of view, some of the at least one factor may be directly associated with the ecdysis of the crustacean set and some of the at least one factor may be indirectly associated with the ecdysis of the crustacean set. Therefore, some of the at least one factor may be adjusted based on a direct/indirect association in the mathematical model to increase a precision of the estimation of the ecdysis information of the crustacean set.

The at least one factor comprises at first factor and a second factor, wherein the relationship set of the mathematical model comprises a relationship subset between the history data associated with the first factor and the ecdysis information of the crustacean set, wherein at least one of the relationship set of the mathematical model, the first factor and the ecdysis information of the crustacean set is adjusted based on the second factor.

In one embodiment, the first factor 51A may be adjusted based on the second factor 52A, which is represented in the form of the second factor 52A (with square frame) embedded in the first factor 51A (with circle frame). Similarly, the first factor 51B may be adjusted based on the second factor 52B, which is represented in the form of the second factor 52B embedded in the first factor 51B. For example, according to the biology of the ecdysis of the shrimp, the age (i.e. first factor) may be an important factor affecting the length of the ecdysis duration; in general, the more the age of the shrimp is, the more the length of the ecdysis duration is; however, poor water quality (i.e. second factor) may decrease the energy of the shrimp so that the ecdysis of the shrimp may be slowed or stop; in other words, the water quality should be taken into account in the length of the ecdysis duration affected by the age; therefore, the factor “age” may be adjusted (e.g., modified age) based on the water quality to increase a precision of the estimation of the ecdysis information of the shrimp (i.e. the crustacean set).

In one embodiment, the relationship set of the mathematical model 53 may be adjusted based on the second factor 52M, which is represented in the form of the second factor 52M (with square frame) embedded in the mathematical model 53. Please see the previous example of the ecdysis of the shrimp, the interior of the mathematical model 53 may have a mechanism or setting for taking into account a combination of the factor “age” and the water quality (i.e. second factor) so that the relationship set of the mathematical model 53 may be adjusted based on the water quality to increase a precision of the estimation of the ecdysis information of the shrimp (i.e. the crustacean set).

In one embodiment, the ecdysis information 51N of the crustacean set (may be used as the output layer of the mathematical model) may be adjusted based on the second factor 52N, which is represented in the form of the second factor 52N (with square frame) embedded in the ecdysis information 51N of the crustacean set. It should be noticed that the output layer of the mathematical model may have a plurality of output nodes but only one output node 51N is presented in the output layer of the mathematical model in FIG. 5 for convenience of description. Please see the previous example of the ecdysis of the shrimp, the water quality (i.e. second factor) may be taken into account in the length of the ecdysis duration affected by the age in the final stage (the output layer) of the mathematical model; therefore, the ecdysis information of the crustacean set may be adjusted based on the water quality to increase a precision of the estimation of the ecdysis information of the shrimp (i.e. the crustacean set).

In one embodiment, the first factor may comprise the biological factor of the crustacean set and the second factor may comprise at least one of a feeding factor and an environment factor. In one embodiment, the first factor may comprise the biological factor of the crustacean set and the second factor may comprise a feeding factor. In one embodiment, the first factor may comprise the biological factor of the crustacean set and the second factor may comprise an environment factor. In one embodiment, the first factor may comprise the biological factor of the crustacean set (may exclude the body feature) and the second factor may comprise the body feature. In one embodiment, the first factor may comprise the biological factor of the crustacean set (may exclude the shell composition) and the second factor may comprise the shell composition.

### Fourth Embodiment in Step 22

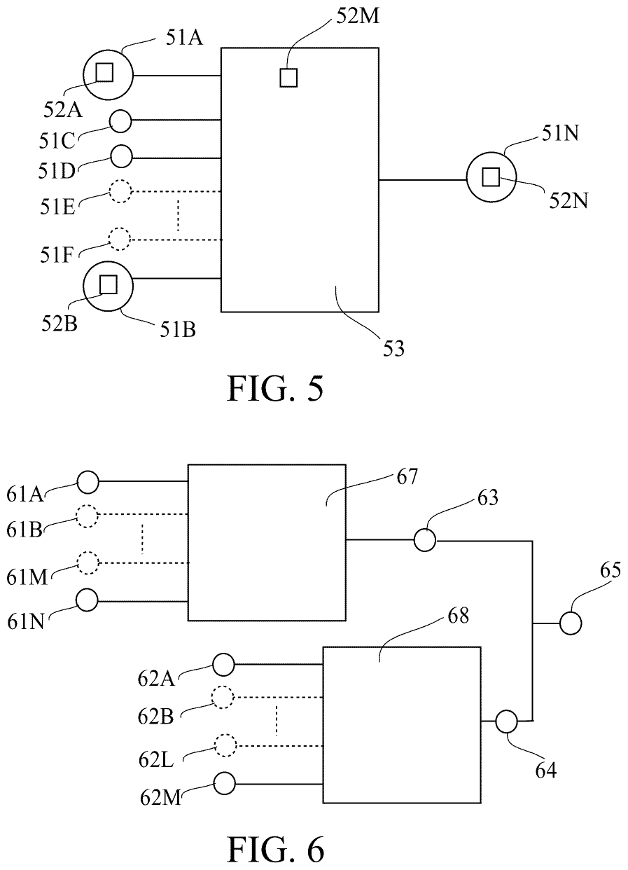

FIG. 6 illustrates a fourth embodiment in step 22 of the present invention. The history data has a corresponding data portion associated with each of at least one factor. The at least one factor is associated with the ecdysis of the crustacean set. From a point of view, some of the at least one factor highly associated with the ecdysis of the crustacean set may be used to coarsely adjust the estimation of the ecdysis information of the crustacean set and some of the at least one factor lowly associated with the ecdysis of the crustacean set may be used to fine adjust the estimation of the ecdysis information of the crustacean set. From another point of view, some of the at least one factor highly associated with the ecdysis of the crustacean set may have the first priority associated with the ecdysis of the crustacean set and some of the at least one factor lowly associated with the ecdysis of the crustacean set may have the second priority associated with the ecdysis of the crustacean set. Therefore, each of the at least one factor can be adjusted base on a degree of association in the mathematical model to increase a precision of the estimation of the ecdysis information of the crustacean set. In one embodiment, the at least one factor comprises at least one first factor 61A-61N (for coarsely adjusting) and at least one second factor 62A-62M (for fine adjusting); the relationship set of the mathematical model comprises a first relationship subset 67 and a second relationship subset 68; the first relationship subset 67 is between the history data associated with the at least one first factor 61A-61N (e.g., the input layer of the first relationship subset 67) and a reference ecdysis information 63 of the crustacean set (e.g., the output layer of the first relationship subset 67); the second relationship subset 68 between the history data associated with the at least one second factor 62A-62M (e.g., the input layer of the second relationship subset 68) and a modified ecdysis information 64 of the crustacean set (e.g., the output layer of the second relationship subset 68); the estimation of the ecdysis information 65 of the crustacean set is determined based on a combination of the reference ecdysis information 63 of the crustacean set and the modified ecdysis information 64 of the crustacean set. For example, according to the biology of the ecdysis of the shrimp, the age (i.e. first factor) may be an important factor affecting the length of the ecdysis duration; in general, the more the age of the shrimp is, the more the length of the ecdysis duration is; however, the feed deficiency may decrease the nutrient of the shrimp so that the ecdysis of the shrimp may be slowed or stop; in other words, the feed factor should be taken into account in the length of the ecdysis duration affected by the age; therefore, the age of the shrimp (i.e. the biological factor of the crustacean set) may be used as a first factor for coarsely adjusting and the feed factor may be used as a second factor for coarsely adjusting to increase a precision of the estimation of the ecdysis information of the shrimp (i.e. the crustacean set).

In one embodiment, the second relationship subset 68 may be between the history data associated with “the at least one first factor 61A-61N and the at least one second factor 62A-62M” (e.g., the input layer of the second relationship subset 68) and the modified ecdysis information 64 of the crustacean set (e.g., the output layer of the second relationship subset 68).

In one embodiment, the at least one first factor may comprise the biological factor of the crustacean set and the at least one second factor may comprise at least one of a feeding factor and an environment factor. In one embodiment, the at least one first factor may comprise the biological factor of the crustacean set and the at least one second factor may comprise a feeding factor. In one embodiment, the at least one first factor may comprise the biological factor of the crustacean set and the at least one second factor may comprise an environment factor. In one embodiment, the at least one first factor may comprise the biological factor of the crustacean set (may exclude the body feature) and the at least one second factor may comprise the body feature. In one embodiment, the at least one first factor may comprise the biological factor of the crustacean set (may exclude the shell composition) and the at least one second factor may comprise the shell composition.

In one embodiment, each of the first relationship subset 67 and the second relationship subset 68 is determined by a (trained) machine learning method. In one embodiment, the first relationship subset 67 is determined by a rule-based method and the second relationship subset 68 is determined by a (trained) machine learning method.

Application in which the Instruction is Executed

Once the estimation of the ecdysis information of the crustacean set is precisely determined in each embodiment in step 22, the present invention can precisely determine the execution of the instruction for farming the crustacean set based on the precise ecdysis information of the crustacean set in step 22.

In one embodiment, the instruction is a protecting instruction for protecting the crustacean set from an attack of an external object. In one embodiment, the external object may be another animal and the protecting instruction may be providing an isolator around the crustacean set to mitigate an attack of another animal. In one embodiment, the external object may be harmful microorganisms and the protecting instruction may be improving the water quality to decrease the growth of the harmful microorganisms. Once the estimation of the ecdysis information of the crustacean set is precisely determined in each embodiment in step 22, the present invention can precisely determine the execution of the protecting instruction for protecting the crustacean set from attacking based on the precise ecdysis information of the crustacean set in step 22. Therefore, the mortality of the crustacean set can decrease and the farmers can have the highest growth/harvest.

In one embodiment, the instruction is a feeding instruction. The feeding instruction may comprise a determination of the feeding parameter. The feeding instruction may comprise a combination of a plurality of feeding parameters. The feeding parameter may comprise a feeding rate, a feeding mount, a feeding frequency, feeding time, a feed size and a feed distribution. The feeding instruction may be an instruction comprising at least one of stopping feeding, beginning to feed and continuing to feed. In one embodiment, the feed may be stopped or be less in the ecdysis duration. In another embodiment, the feed may be continuous or be more in the ecdysis interval.

Once the estimation of the ecdysis information of the crustacean set is precisely determined in each embodiment in step 22, the present invention can precisely determine the execution of the feeding instruction based on the precise ecdysis information of the crustacean set in step 22. Therefore, the present invention can provide the reasonable feeding instruction to avoid the drawback result form more feed/less feed and save more time compared to a manual process of monitoring/adjusting feed; therefore, the farmers can have the highest growth of the harvest by using the least amount of feed to produce a desired output.

### Improvement of a Confidence of Using the Mathematical Model

In order to definitely determine the execution of the instruction for farming the crustacean set, a confidence of using the mathematical model can be taken into account. In one embodiment, the execution of the instruction for farming the crustacean set may be determined further based on a comparison between the ecdysis information of the crustacean set and an ecdysis criterion. The ecdysis information of the crustacean set and the ecdysis criterion may be substantially in the same location of an axis of time.

The ecdysis criterion or the source/raw data of the ecdysis criterion may be not derived from history data associated with the ecdysis of the crustacean set. Take the ecdysis parameter of the ecdysis information being whether the ecdysis happens or not and the crustacean set having a crustacean X for example; please refer back to FIG. 3A, at the first time point T1, the crustacean X at the first time point T1 is determined to be in the ecdysis state based on the history data (before the first time point T1) associated with the ecdysis of the crustacean X by the mathematical model. The ecdysis criterion may be whether an ecdysis happens at the first time point T1, which is not derived from history data (before the first time point T1) associated with the ecdysis of the crustacean X. If the ecdysis criterion represents that the crustacean X at the first time point T1 is in the ecdysis state which represents a high confidence of using the mathematical model, the execution of the instruction for farming the crustacean set may be definitely determined. If the ecdysis criterion represents that the crustacean X at the first time point T1 is in the non-ecdysis state which represents a low confidence of using the mathematical model, the execution of the instruction for farming the crustacean set may be not definitely determined. In this case shown in FIG. 3A, the ecdysis criterion (e.g., based on the sensing data of the crustacean set in the next paragraph) the represents that the crustacean X at the first time point T1 is in the ecdysis state (the dashed line T1 passes through the actual ecdysis duration (with symbol D)) which represents a high confidence of using the mathematical model, so the execution of the instruction for farming the crustacean set may be definitely determined.

In one embodiment, the ecdysis criterion may be determined based on the sensing data of the crustacean set acquired by a sensing unit 11 (e.g., at the first time point T1). The sensing unit 11 may be an image sensor, such as a camera (i.e. whether the ecdysis happens or not is determined by an image processing method). The sensing unit 11 may be an acoustic sensor (i.e. whether the ecdysis happens or not is determined by a sound processing method). However, the present is not limited to these cases.

The ecdysis criterion or the source/raw data of the ecdysis criterion may be derived from the early history data associated with the ecdysis of the crustacean set. Take the ecdysis parameter of the ecdysis information being whether the ecdysis happens or not and the crustacean set having a crustacean X for example; please see FIG. 3B, at the first time point T1, the crustacean X at the second time point T2 is determined to be in the ecdysis state based on the history data (before the first time point T1) associated with the ecdysis of the crustacean X by the mathematical model. The ecdysis criterion may be whether the ecdysis happens at the second time point T2, which is derived from early history data (before the third time point T3) associated with the ecdysis of the crustacean X (e.g., by the mathematical model). The third time point T3 is earlier than the first time point T1. At least one portion of the history data is between the third time point T3 and the first time point T1. If the ecdysis criterion represents that the crustacean X at the second time point T2 is in the ecdysis state which represents a high confidence of using the mathematical model, the execution of the instruction for farming the crustacean set may be definitely determined. If the ecdysis criterion represents that the crustacean X at the second time point T2 is in the non-ecdysis state which represents a low confidence of using the mathematical model, the execution of the instruction for farming the crustacean set may be not definitely determined. In this case shown in FIG. 3B, the ecdysis criterion (e.g., based on sensing the early history data before the third time point T3) represents that the crustacean X at the second time point T2 is in the ecdysis state (the dashed line T2 passes through the actual ecdysis duration (with symbol D)) which represents a high confidence of using the mathematical model, so the execution of the instruction for farming the crustacean set may be definitely determined.

In this example taken in FIG. 3B, the second time point T2 can be also changed to a time point not earlier than the first time point T1.

Please continue to see the example taken in FIG. 3B. At the first time point T1 earlier than the second time point T2, if the ecdysis information of the crustacean X at the second time point T2 does not meet the ecdysis criterion (i.e. it is not suitable that apply at least one portion of the history data between the third time point T3 and the first time point T1 to the mathematical model; the ecdysis information of the crustacean X at the second time point T2 determined by the mathematical model may be not adopted), at least one portion of the history data between the third time point T3 and the first time point T1 can be provided to modify the mathematical model such that the ecdysis information of the crustacean X at the second time point T2 can be determined more precisely by the mathematical model in the duration between the first time point T1 and the second time point T2. As time goes on, for each time point T1′ corresponding to the first time point T1, if the ecdysis information of the crustacean X at the time point T2′ corresponding to the second time point T2 does not meet the ecdysis criterion, the process of modifying the mathematical model can be executed such that the ecdysis information of the crustacean X at the time point T2′ can be determined more precisely by the mathematical model in the duration between the time point T1′ and the time point T2′. The length of the duration between the time point T1′ and the time point T2′ may be determined based on a degree of inconsistency between the ecdysis information of the crustacean X at the time point T2′ and the ecdysis criterion.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for optimizing a growth of a crustacean set, the method comprising:
(a) acquiring, from a memory unit, history data associated with an ecdysis of the crustacean set;
(b) determining, by a processing unit, an estimation of the ecdysis information of the crustacean set based on the history data associated with the ecdysis of the crustacean set by a mathematical model describing a relationship set between the history data associated with the ecdysis of the crustacean set and the ecdysis information of the crustacean set; and
(c) determining, by the processing unit, an execution of an instruction for farming the crustacean set based on the estimation of the ecdysis information of the crustacean set.

2. The method according to claim 1, wherein a duration has a first time point and a second time point, wherein the second time point is in the duration beginning at the first time point, wherein the ecdysis information of the crustacean set is at the second time point and the ecdysis information of the crustacean set at the second time point is determined at the first time point.

3. The method according to claim 1, wherein the ecdysis information comprises an ecdysis parameter represented in the form of time when the ecdysis of the crustacean set happens.

4. The method according to claim 3, wherein the ecdysis parameter comprises at least one of a length of an ecdysis duration, a beginning time of the ecdysis duration, an ending time of the ecdysis duration and a length of an ecdysis interval between two adjacent ecdysis durations.

5. The method according to claim 3, wherein step (b) comprises:
acquiring a tendency of the ecdysis parameter from the history data associated with the ecdysis of the crustacean set; and
determining a value of the ecdysis parameter of the crustacean set based on the tendency of the ecdysis parameter;
wherein the relationship set of the mathematical model comprises a first relationship subset between the tendency of the ecdysis parameter and the value of the ecdysis parameter of the crustacean set.

6. The method according to claim 5, wherein the history data associated with the ecdysis of the crustacean set is history ecdysis data of the crustacean set.

7. The method according to claim 6, wherein the value of the ecdysis parameter of the crustacean set is determined further based on at least one of a length of a latest ecdysis duration, a beginning time of the latest ecdysis duration, an ending time of the latest ecdysis duration and a length of a latest ecdysis interval between two adjacent ecdysis durations.

8. The method according to claim 5, wherein the history data associated with the ecdysis of the crustacean set is history ecdysis data of a different crustacean set associated with the crustacean set.

9. The method according to claim 3, wherein the history data associated with the ecdysis of the crustacean set comprises history ecdysis data of a different crustacean set associated with the crustacean set, wherein the different crustacean set has a first age and a second age larger than the first age, wherein step (b) comprises:
acquiring a tendency of the ecdysis parameter between the first age and the second age from the history ecdysis data of the different crustacean set associated with the crustacean set; and
determining a value of the ecdysis parameter of the crustacean set at a third age between the first age and the second age based on the tendency of the ecdysis parameter between the first age and the second age;
wherein the relationship set of the mathematical model comprises a first relationship subset between the tendency of the ecdysis parameter of the different crustacean set between the first age and the second age and the value of the ecdysis parameter of the crustacean set at the third age.

10. The method according to claim 3, wherein the history data associated with the ecdysis of the crustacean set comprises first history ecdysis data of a different crustacean set associated with the crustacean set and second history ecdysis data of the crustacean set, wherein the different crustacean set has a first age and a second age larger than the first age, wherein step (b) comprises:
acquiring a tendency of the ecdysis parameter between the first age and the second age from the first history ecdysis data of the different crustacean set associated with the crustacean set; and
determining a value of the ecdysis parameter of the crustacean set at a third age between the first age and the second age based on the tendency of the ecdysis parameter between the first age and the second age and the second history ecdysis data of the crustacean set;
wherein the relationship set of the mathematical model comprises a first relationship subset among the tendency of the ecdysis parameter of the different crustacean set between the first age and the second age, the second history ecdysis data of the crustacean set and the value of the ecdysis parameter of the crustacean set at the third age.

11. The method according to claim 10, wherein the second history ecdysis data of the crustacean set comprises at least one of a length of a latest ecdysis duration, a beginning time of the latest ecdysis duration, an ending time of the latest ecdysis duration and a length of a latest ecdysis interval between two adjacent ecdysis durations.

12. The method according to claim 5, wherein the history data has a corresponding data portion associated with each of at least one factor, wherein the at least one factor is associated with the ecdysis of the crustacean set, further comprising:
modifying the value of the ecdysis parameter of the crustacean set based on a portion of the at least one factor;
wherein the relationship set of the mathematical model further comprises a second relationship subset between the history data associated with the portion of the at least one factor and the value of the ecdysis parameter of the crustacean set.

13. The method according to claim 12, wherein the portion of the at least one factor excludes the factor associated with at least one tendency factor used to acquire the tendency.

14. The method according to claim 1, wherein the history data has a corresponding data portion associated with each of at least one factor, wherein the at least one factor is associated with the ecdysis of the crustacean set, wherein the relationship set of the mathematical model comprises a relationship subset between the history data associated with the at least one factor and the ecdysis information of the crustacean set.

15. The method according to claim 14, wherein the mathematical model is a machine learning model.

16. The method according to claim 1, wherein the history data has a corresponding data portion associated with each of at least one factor, wherein the at least one factor is associated with the ecdysis of the crustacean set, wherein the at least one factor comprises at first factor and a second factor, wherein the relationship set of the mathematical model comprises a relationship subset between the history data associated with the first factor and the ecdysis information of the crustacean set, wherein at least one of the relationship set of the mathematical model, the first factor and the ecdysis information of the crustacean set is adjusted based on the second factor.

17. The method according to claim 1, wherein the history data has a corresponding data portion associated with each of at least one factor, wherein the at least one factor is associated with the ecdysis of the crustacean set, wherein the at least one factor comprises at least one first factor and at least one second factor, wherein the relationship set of the mathematical model comprises:
a first relationship subset between the history data associated with the at least one first factor and a reference ecdysis information of the crustacean set; and
a second relationship subset between the history data associated with the at least one second factor and a modified ecdysis information of the crustacean set;
wherein the estimation of the ecdysis information of the crustacean set is determined based on a combination of the reference ecdysis information of the crustacean set and the modified ecdysis information of the crustacean set.

18. The method according to claim 1, wherein the instruction is a protecting instruction for protecting the crustacean set from an attack of an external object.

19. The method according to claim 1, wherein the instruction is a feeding instruction.

20. The method according to claim 1, wherein the execution of the instruction for farming the crustacean set is determined further based on a comparison between the ecdysis information of the crustacean set and an ecdysis criterion.

21. The method according to claim 20, wherein the ecdysis information of the crustacean set and the ecdysis criterion are substantially in the same location of an axis of time.

22. The method according to claim 21, wherein the ecdysis criterion is not derived from the history data associated with the ecdysis of the crustacean set.

23. The method according to claim 22, wherein the ecdysis criterion is determined based on sensing data of the crustacean set acquired by a sensing unit.

24. The method according to claim 23, wherein the sensing unit is a camera.

25. The method according to claim 21, wherein a duration has a first time point and a second time point, wherein the second time point is in a duration beginning at the first time point, wherein the ecdysis information of the crustacean set is at the second time point and the ecdysis information of the crustacean set at the second time point is determined at the first time point, wherein the ecdysis criterion is derived from early history data associated with the ecdysis of the crustacean set, wherein the history data is before the first time point and the early history data is before a third time point, wherein the third time point is earlier than the first time point.

26. The method according to claim 1, wherein the history data associated with the ecdysis of the crustacean set is history ecdysis data of the crustacean set.

27. The method according to claim 1, wherein the history data associated with the ecdysis of the crustacean set is history ecdysis data of a different crustacean set associated with the crustacean set.

28. The method according to claim 27, wherein the different crustacean set associated with the crustacean set is determined by a criterion, wherein the criterion is determined based on a similarity of a biological factor of the crustacean set.

29. The method according to claim 27, wherein the different crustacean set associated with the crustacean set is determined by a criterion, wherein the criterion is determined based on a similarity of growth history of the crustacean set.

30. The method according to claim 1, wherein the history data has a corresponding data portion associated with each of at least one factor, wherein the at least one factor is associated with the ecdysis of the crustacean set, wherein the at least one factor comprises at least one of a biological factor of the crustacean set, a feeding factor, an environment factor and a history ecdysis factor.

31. The method according to claim 1, wherein the ecdysis information comprises an ecdysis parameter, wherein the ecdysis parameter comprises whether the ecdysis happens or not and an ecdysis ratio of the crustacean set.

32. The method according to claim 1, wherein the crustacean set is a shrimp set.

33. A method for optimizing a growth of a shrimp set, the method comprising:
(a) acquiring, from a memory unit, history data associated with an ecdysis of the shrimp set;
(b) determining, by a processing unit, an estimation of the ecdysis information of the shrimp set based on the history data associated with the ecdysis of the shrimp set by a mathematical model describing a relationship set between the history data associated with the ecdysis of the shrimp set and the ecdysis information of the shrimp set; and
(c) determining, by the processing unit, an execution of an instruction for farming the shrimp set based on the estimation of the ecdysis information of the shrimp set;
wherein a duration has a first time point and a second time point, wherein the second time point is in the duration beginning at the first time point, wherein the ecdysis information of the shrimp set is at the second time point and the ecdysis information of the shrimp set at the second time point is determined at the first time point;
wherein the history data has a corresponding data portion associated with each of at least one factor, wherein the at least one factor is associated with the ecdysis of the shrimp set, wherein the at least one factor comprises a biological factor of the shrimp set, a feeding factor and an environment factor;
wherein the history data associated with the ecdysis of the shrimp set comprises history ecdysis data of a different shrimp set associated with the shrimp set, wherein the different shrimp set associated with the shrimp set is determined by a criterion, wherein the criterion is determined based on a similarity of the biological factor of the shrimp set.

34. The method according to claim 33, wherein the instruction is a protecting instruction for protecting the shrimp set from an attack of an external object.

35. The method according to claim 33, wherein the instruction is a feeding instruction.

36. A method for optimizing a growth of a shrimp set, the method comprising:
(a) acquiring, from a memory unit, history data associated with an ecdysis of the shrimp set;
(b) determining, by a processing unit, an estimation of the ecdysis information of the shrimp set based on the history data associated with the ecdysis of the shrimp set by a mathematical model describing a relationship set between the history data associated with the ecdysis of the shrimp set and the ecdysis information of the shrimp set; and
(c) determining, by the processing unit, an execution of an instruction for farming the shrimp set based on the estimation of the ecdysis information of the shrimp set;
wherein a duration has a first time point and a second time point, wherein the second time point is in the duration beginning at the first time point, wherein the ecdysis information of the shrimp set is at the second time point and the ecdysis information of the shrimp set at the second time point is determined at the first time point;
wherein the history data has a corresponding data portion associated with each of at least one factor, wherein the at least one factor is associated with the ecdysis of the shrimp set, wherein the at least one factor comprises a biological factor of the shrimp set;
wherein the history data associated with the ecdysis of the shrimp set comprises history ecdysis data of a different shrimp set associated with the shrimp set, wherein the different shrimp set associated with the shrimp set is determined by a criterion, wherein the criterion is determined based on a similarity of growth history of the shrimp set.

37. The method according to claim 36, wherein the instruction is a protecting instruction for protecting the shrimp set from an attack of an external object.

38. The method according to claim 36, wherein the instruction is a feeding instruction.
